(19) United States
(12) Patent Application Publication
(10) Pub. No.: US 2023/0265014 A1
(43) Pub. Date: Aug. 24, 2023

(54) HIGH EMISSIVITY REFRACTORY MATERIALS AND REFRACTORY COMPONENTS FORMED THEREOF

(71) Applicant: FOSBEL WAHL HOLDINGS, LLC, Green Creek, OH (US)

(72) Inventors: Geoffrey W. PERDUE, Green Creek, OH (US); Angela RODRIGUES-SCHROER, Green Creek, OH (US); Stephen D. CHERICO, Green Creek, OH (US)

(21) Appl. No.: 18/015,215

(22) PCT Filed: Jul. 9, 2021
(86) PCT No.: PCT/US2021/041040

§ 371 Date: Jan. 9, 2023

Related U.S. Application Data
(60) Provisional application No. 63/050,381, filed on Jul. 10, 2020.

(51) Int. Cl. C04B 14/04; C04B 28/02; C04B 14/30; C04B 38/10

(52) U.S. Cl. CPC C04B 14/041; C04B 28/02; C04B 14/308; C04B 38/10; C04B 2103/54

(57) ABSTRACT

Particulate high-emissivity (high-ε) refractory products include a mixture of (a) a particulate refractory base material which includes at least one particulate binder material, at least one particulate refractory raw material filler material and optionally at least one refractory additive; and (b) a high-ε pigment in an amount sufficient to impart high-ε properties to the refractory product when cured of at least 0.80. The high-ε pigment is homogenously dispersed throughout the particulate refractory base material and is thereby less susceptible to loss of high-ε properties over time. The particulate high-ε products may be formed into an castable wet mix, an aqueous slurry or an insulating aqueous foam and cured so as to provide a component part of a high temperature refractory structure (e.g., the walls or ceiling of a refractory furnace) having high-ε properties.

### CROSS-REFERENCE TO RELATED APPLICATION

This application is based on and claims domestic priority benefits of U.S. Provisional Application Ser. No. 63/050,381 filed on Jul. 10, 2020, the entire contents of which are expressly incorporated herein by reference.

### FIELD

The embodiments disclosed herein relate generally to high temperature resistant (refractory) materials. In preferred forms, the embodiments disclosed herein relate to refractory materials which when cured exhibit high emissivity (ε) characteristics. Preferred embodiments disclosed herein relate to refractory materials whereby high-emissivity (high-ε) pigments dispersed homogenously throughout the material. The refractory materials may be in the form of a dry mixture of particulate components which in turn may be formed into an aqueous slurry, refractory foam or a castable refractory.

### BACKGROUND AND SUMMARY

Currently, high-emissivity coatings are produced for industrial furnaces and process heaters. The coatings are prepared from ceramic base materials, with high emissivity pigments containing materials such as cobalt, nickel, chrome, and iron oxides. A number of these pigments are commercially available and can be mixed into the base refractory material in amounts ranging from about 1 wt. % to about 5 wt. %, based on the dry weight of the refractory material. The coatings are then applied as thin layers (e.g., a layer thickness of about 1.6 mm) onto existing furnace linings.

Based on the Stefan Boltzmann equation (P=εAσT⁴), where ε is emissivity, the change in emissivity provided by the high-emissivity coatings may result in increases of radiant heat transfer on the order of 40%. Because emissivity is a surface effect, the benefits provided by the change in emissivity on the outermost surface of the furnace linings from the coatings are notable. For example, the coatings improve the radiant heat transfer of a refractory surface onto the furnace load of natural gas-fired furnaces by increasing the emissivity of the surface of the refractory (typically fairly low 0.4 to 0.65) up to about 0.92.

Accordingly, the high-emissivity coating provides operational and financial benefits in industries where energy costs are high, such as refineries, chemical plants, and steel finishing mills. The benefits are provided immediately (i.e., immediately after the coating is applied) and will last as long as the coating remains on the furnace linings. However, conventional high-ε coatings applied to furnace linings eventually deteriorate and flake off as the refractory component deteriorates. Self-evidently, therefore, as the coating is removed the high-ε benefits provided by the coating will diminish over time.

Another problem with high-ε refractory coatings is the conventional use of ceramic refractory fibers (CRFs), typically aluminosilicate fibers, forming the ceramic blanket and furnace linings to provide insulating properties. While such CRFs offer increased insulation, they break down over time when exposed to high temperatures and become brittle and friable. The turbulence of the furnace combustion due to gas and air combusting and blowing through the furnace will cause such degraded CRFs to dislodge and move downstream through the furnace. As the dislodged fibers move downstream, they may settle into the pre-stack heat recovery system, thus lowering its efficiency and eventually clogging it. Alternatively, the fibers may continue downstream and exit the system, wherein they would be deposited around the surrounding environment. As CRFs have been shown to be carcinogenic, this issue presents health and environmental risks and is thus to be strictly avoided.

It is an objective of the embodiments disclosed herein to incorporate high-emissivity pigments directly into a refractory base material, such as refractory insulating foams, cast-in-place materials, gunning/shotcrete materials, bricks, moldable materials, or other precast refractory castable materials for high-temperature applications (e.g., greater than about 450° F.). Exemplary applications in which the refractory products described herein may be employed include the walls and ceilings of high temperature melting furnaces used in the aluminum industry. By incorporating high-ε pigments into and dispersing such pigments throughout the refractory base material, the concentration of the pigments is homogenously distributed throughout a refractory structure formed of the material. Alternatively, the concentration of the high-ε pigments may be homogenously distributed up to a specific predefined depth (e.g. one or more inches) within the refractory base material.

Incorporating the pigments into the refractory base materials thereby provides improved emissivity for the materials and eliminates the problems associated with the deterioration of coatings which flake off over time. Since the high-ε pigments are physically within the refractory material, the surface of the refractory material may be cleaned to remove emissivity-reducing contaminants that build up on the surface to thereby expose the refractory material and restore its high-ε properties. Furthermore, incorporation of the pigments directly into the refractory base materials results in only a small increase in total production cost, as the pigments conventionally would have been applied only to a top surface. The provision of high-ε surface is a one-step process using the high-ε refractory materials of the embodiments disclosed which incorporate the high-ε pigments physically within the refractory base material since once the material is installed the project is completed, i.e., no additional coating or layer must be applied to the material surface in order to achieve high-ε properties.

These and other aspects and advantages of the present invention will become more clear after careful consideration is given to the following detailed description of the preferred exemplary embodiments thereof.

### DETAILED DESCRIPTION OF EMBODIMENTS

A granulate refractory material with high-emissivity pigments incorporated into the material for use in high-temperature applications and methods by which such refractory material may be used as a flowable mass which when cured form high-temperature refractory structures (e.g., walls, ceilings, blocks and the like employed in high-temperature environments) are disclosed. The refractory material includes, for example, refractory insulating foams, cast-in-place materials, gunning/shotcrete materials, bricks, moldable materials, or other precast refractory castable materials for use in high-temperature applications and environments. The term “high-temperature” as it relates to the present disclosure is a temperature that is equal to or greater than 450° F., such as a temperature range of 450° F. to 2800° F. or even 1200° F. to 2800° F.

By incorporating the high-emissivity pigments directly into a refractory base material, the concentration of the pigments in the resulting granular refractory material is homogenously distributed throughout at least a predetermined portion or the entirety of the depth of the resulting refractory structure or component when cured. Such homogenous distribution of high-ε pigments is thus in direct contrast to conventional high-ε coatings whereby the high-ε pigments are present only within a relatively thin top coating. According to the embodiment disclosed herein, therefore, the high-ε pigments are not susceptible to removal by flaking or by some other mechanical force/damage as compared to conventional thin high-ε coatings. Further, there is no need for the refractory substrate to which conventional high-ε coatings are applied to be dried out thereby minimizing the idling of equipment and the refractory component.

The high-emissivity pigments may be incorporated into a dry granulate mixture of virtually any type of refractory base material, including high cement, low cement, no cement, colloidal, slurries, and phosphoric acid binding systems. The dry mixture of the refractory base material will therefore typically include a combination of one or more particulate binder materials, one or more particulate refractory raw material filler materials, and optionally one or more particulate refractory additives.

The particulate refractory base materials will typically possess a predetermined target particle size distribution (Dₚₛₜ) that will impart suitable flowability to an aqueous slurry of the particulate refractory materials. In preferred embodiments, the particulate refractory base materials will typically possess the following Dₚₛₜ: 4 mesh<2%; 10 mesh=23% +/−5%; 20 mesh=42% +/−5%; 100 mesh=58% +/−5%; 200 mesh=64% +/−5% and −325 mesh=32% +/−5%.

The particulate binder materials will typically be present in the dry mixture of the refractory base material in an amount of about 2 wt. % to about 30 wt. %, preferably between about 2 wt. % to about 10 wt. % (for example about 4 wt.%) based on total weight of the particulate high-ε refractory material product. The binder materials are provided in sufficient amounts to promote the development of green mechanical properties of the cured refractory material. One or more binder materials may be used in the dry mixture of the refractory based material.

Exemplary particulate binder materials include calcium aluminate cements, hydratable alumina, phosphate-based binders, sodium silicate, colloidal silica, and colloidal alumina. An exemplary calcium aluminate cement includes SECAR® 71 (CAS #65997-16-2, hydraulic binder with the following specifications: Al2O3 (≥68.5%), CaO (≤31.0%), SiO2 (≤0.8%), and Fe2O3 (≤0.4%)) (commercially available from KERNEOS Inc.). An exemplary hydratable alumina includes DYNABOND™ 3 (CAS #1344-28-1, flash calcined hydratable alumina powder) (commercially available from ALUCHEM, Inc.). An exemplary phosphate-based binder includes phosphoric acid 85% FG (commercially available from Brenntag) and monoaluminum phosphate. An exemplary sodium silicate includes SS®-C 20 (CAS #1344-09-8, sodium silicate powder) (commercially available from PQ Corporation). An exemplary colloidal silica includes LUDOX® TM-40 (CAS #7631-86-9, 40 weight percent suspension in water) (commercially available from Sigma Aldrich). An exemplary colloidal alumina includes ALR-0105 (0.5 micron fine alumina polishing powder) (commercially available from Pace Technologies).

The particulate refractory raw material filler materials are provided so as to impart the desired general properties of the refractory, such as the final chemistry that is specific for each end use application. The refractory raw material filler materials will typically be present in an amount of 50 wt. % to about 99 wt. %, preferably between about 75 wt. % to about 95 wt. % (for example between about 85 wt. % to about 90 wt. %), based on total dry weight of the refractory base material, based on total weight of the particulate high-ε refractory material product.

The refractory raw material filler materials that may be used satisfactorily in the dry mixture of the refractory base material include one or more of alumina-silicates, aluminas, silicon carbides, zirconia-containing raw materials, magnesium-aluminum spinels, silica fume, calcined flint, fused silica and silica sand. The refractory raw material fillers provide the general properties of the refractory, such as the final chemistry that is specific for each application. The particulate refractory raw material fillers have a particle size that is 3 mesh and finer, for example, below 40 mesh such as about 48 mesh, 100 mesh, 200 mesh, 325 mesh, 400 mesh, 600 mesh and the like.

Exemplary alumina-silicates that may be employed include kyanite (e.g. Virginia Kyanite™ 48 mesh, 100 mesh, 200 mesh, or 325 mesh, commercially available from Kyanite Mining Corporation, Dillwyn, Va.), mullite (e.g. Virginia Mullite 48 mesh, 100 mesh, 200 mesh, or 325 mesh, commercially available from Kyanite Mining Corporation, Dillwyn, Va.), and MULCOA® 47, 60, or 70 having particle size of 3 mesh or finer, for example, 48 mesh, 100 mesh, 200 mesh, or 325 mesh, commercially available from Imerys Refractory Minerals, Roswell, Ga.), and andalusite (e.g. Randalusite™, commercially available from Imerys Fused Minerals, Roswell, Ga.).

Exemplary aluminas that may be employed include calcined alumina (e.g. AC2-325 and AC2-325SG, commercially available from AluChem, Inc., Cincinnati, Ohio), thermally reactive alumina (e.g. AC17RG and AC19RG, commercially available from AluChem, Inc., Cincinnati, Ohio), reactive alumina (e.g. P172SB, commercially available from Alteo, Gardanne, France), tabular alumina (e.g. AC99, commercially available from AluChem, Inc., Cincinnati, Ohio), bauxite (e.g. RD-88, commercially available from Great Lake Minerals) and fused alumina commercially available from Imerys Fused Minerals of Greeneville, Tenn. and FX Minerals Group of Newell, W. Va.

An exemplary silicon carbide that may be employed includes silicon carbide having a particle size of 3 mesh and finer, commercially available from ElectroAbrasives, Buffalo, N.Y.

Exemplary zirconia-containing raw materials include zircon flour and zirconia alumina silicate (e.g. DURAMUL® ZR, commercially available from Washington Mills) as well as dry milled zircon of 3 mesh and finer (e.g. 200 mesh, 325 mesh, 400 mesh, 600 mesh, commercially available from Continental Mineral Processing, Cincinnati, Ohio).

An exemplary magnesium-aluminum spinel that may be employed includes Spinel AR 78 (alumina-rich spinel, 78% Al2O3, commercially available from Almatis, Inc.).

An exemplary silica fume includes NS-950 and NS-980, commercially available from Technical Silica Co., Atlanta, Ga., an exemplary fused silica is TecoSil® fused silica commercially available from Imerys Refractory Materials of Greeneville, Tenn. and an exemplary silica sand (crystalline silica) is commercially available from U.S. Silica Company of Katy, Tex.

Virtually any additive conventionally employed in refractory materials may satisfactorily be employed in the particulate refractory materials of the embodiments described herein depending on the application requirements. The additives that may optionally be present include, for example, dispersants, coagulants including set time accelerants and set time retardants, flocculants, deflocculants, plasticizers, colorants, foaming agents, water-retaining agents, anti-settling agents, preservatives and the like. The particulate additives may also include ceramic and/or polymeric fibrous materials. The total amount of all additives present in the particulate material will preferably be employed up to about 15 wt. %, for example, between about 0.01 wt. % to about 15 wt. % or more typically between about 0.02 wt. % to about 10 wt. %, based on total weight of the particulate high-ε refractory material product.

The refractory base materials of the embodiments described herein will necessarily include an amount of high-ε pigments sufficient to impart desired high-ε to the refractory material when cured. Virtually any high-ε pigment conventionally employed in refractory coating applications can similarly be employed in the refractory materials of the embodiments described herein. Preferred are pigments which, when incorporated into a refractory material will impart to such refractory material when cured the ability to emit radiation energy over a broad spectrum, e.g., to impart a “blackbody” effect to the cured refractory material. In certain embodiments, the high-e pigments will, for example, be incorporated into the refractory material in an amount sufficient to cause the refractory material when cured to emit radiation energy over a wavelength of greater than about 0.1 μm up to about 3.0 μm.

Preferred for use as the high-ε pigments in the embodiments of the particulate material products disclosed herein are inorganic high-temperature inorganic metal oxides or carbides that provide such broad spectrum emissivity mentioned above to the cured refractory material. Especially preferred are oxides of chromium, tin, iron (especially black iron oxide) and cerium. For example, suitable high-ε pigments include iron oxide pigments, chromium-iron black pigment, cadmium-chromium-iron-nickel black pigment, nickel-manganese-iron-chromium black pigment, chromium green pigment, iron-cobalt-chromium black pigment, iron-chromium black pigment, and iron-cobalt-chromium black pigment. Exemplary high-ε pigments are further disclosed in U.S. Pat. Nos. 9,499,677 and 10,400,150, the entire contents of which are expressly incorporated hereinto by reference.

Commercially available high-ε pigments include Pigments BK-5099, BK-4799, R-3098, and YLO-2288D (commercially available from Brenntag Specialties, Reading, Pa.); Cerdec 41776A Black Pigment; Cerdec 41117A Black Pigment; Cerdec 10333 Black Pigment; Chrome Oxide (G4099) (commercially available from Harcros, Kansas City, Kans.); Black Pigment 6600 (commercially available from Mason Color Works, East Liverpool, Ohio); Pigments 1606 and 1607 (commercially available from Ceramic Color & Chemical, New Brighton, Pa.); chromite flour (commercially available from American Minerals); and iron cobalt chromite black spinel (PBk27) (commercially available from Ferro, Mayfield Heights, Ohio).P One specific commercially available high-ε pigment that may be used satisfactorily in the practice of this invention is LANOX™ 8303T Hi-Temp Black Iron Oxide from Lansco Colors of Pearl River, N.Y.

Preferably, the high-ε pigments will be present in the particulate refractory material products described herein in an amount sufficient to achieve emissivity (ε) of greater than about 0.80, preferably between about 0.80 to about 0.95 and more preferably between about 0.90 to about 0.93. Specifically, the high-ε pigments will be present in the particulate refractory materials described herein in an amount of up to about 20 wt. %, for example, between about 2 wt. % to about 20 wt. % or more typically between about 3 wt. % to about 10 wt. %, and most preferably about 4 wt. % to about 8 wt. % (e.g., about 6 wt. % to about 8 wt. %), based on total weight of the particulate high-ε refractory material product.

The addition of the high-ε pigment will likely deleteriously affect the Dₚₛₜ of the particulate refractory base material and could therefore in turn deleteriously affect the desirable physical properties associated with such refractory base material. It is therefore sometimes required that the final particle size distribution (D_{psf}) of the high-ε pigment containing particulate refractory material product according to the embodiments disclosed herein is reset or adjusted so as to substantially coincide with or be substantially equivalent to the Dₚₛₜ of the refractory base material as described previously. According to preferred embodiments, such a reset or adjustment of the particle size distribution is achieved by the addition of a particulate refractory size adjusting component in an amount that resets the particle size distribution after addition of the high-ε pigment so that D_{psf} of the final particulate refractory material product is substantially the same as the Dₚₛₜ of the particulate refractory base material.

In addition to meeting the particle size distribution requirements described above, the particle size distribution adjusting component should also not substantially detract from the broad spectrum emitting effect achieved by the addition of the high-ε pigment. Exemplary preferred particle size distribution adjusting components include inorganic metal oxides such as brown and/or white fused alumina as well as silicon carbide. Brown fused alumina is especially preferred. Even with the addition of the particle size distribution adjusting component, it may also be necessary to adjust slightly the constituent amounts of one or more of the components present in the refractory base material.

The particle size distribution adjusting component will typically possess an average particle size distribution of: +30 mesh=10% max.; −30/+40 mesh=5-15%; −40/+70 mesh=20-50%; −70/+100 mesh=10-20 mesh; −100/+140 mesh=5-15% and −140/+325 mesh=20-30%. The particle size distribution adjusting component will typically be present in the particulate refractory materials described herein in an amount of up to about 20 wt. %, for example, between about 4 wt. % to about 20 wt. % or more typically between about 6 wt. % to about 12 wt. % (e.g., between about 8 wt. % and 10 wt. %), based on total weight of the particulate high-ε refractory material product.

The necessary particulate components, including the components of the refractory base material and the high-ε pigment may be dry mixed using a conventional refractory mixer in order to prepare a dry mixture of the refractory material product. If required, the particle size adjustment component may be added concurrently with or separately to the components of the refractory base material and the high-ε pigment or may be added. Water may then added to the dry mixture to prepare an aqueous castable wet mix having desired flowability characteristics. Specifically, the dry mix of the refractory material product possessing the Dpt will be mixed with sufficient water so that the resulting slurry exhibits a Tap Flow according to ASTM Standard C1445-99 of between about 15% to about 80%, more preferably between about 15% to about 50%, e.g., between about 20% to about 35%. The castable wet mix may then subsequently be poured into a mold and allowed to cure to form a refractory structure or component.

The high-ε refractory material product as described herein may also be formed into a refractory slurry or an insulating foam. The refractory slurry or the insulating foam may thus prepared by first combining the particulate components, including the high-ε pigment to form a dry mixture as described above. Water may then be added to the dry mixture to prepare the aqueous slurry that may be used in such form for certain applications. In order to prepare an insulating refractory foam, the slurry may then be combined with a conventional foaming material to yield the refractory insulating foam. The refractory insulating foam may then be cured and allowed to harden. Conventional foaming materials include, for example, FM160™ foam agent from Drexel Chemical Company of Memphis, Tenn.

The following non-limiting examples will provide a further understanding of specific embodiments according to this invention.

### EXAMPLES

### Example 1

The following dry mix formulations identified in Table 1 below were employed using a conventional particulate refractory material (WalMaxXx™ 60M, an approximately 60 wt. % mullite based alumina, ultra-low cement castable conventional refractory material commercially available from Wahl Refractory Solutions of Fremont, Ohio) as the base material and a black iron oxide pigment (Lanox™ 8303T Hi-Temp Black Iron Oxide commercially available from Lansco Colors of Pearl River, N.Y.) as the high-ε pigment.

TABLE 1

| Component | F1 | F2 | F3 | F4 | F5 |
|---|---|---|---|---|---|
| Base Material (wt. %) | 100 | 98 | 96 | 94 | 92 |
| High-ε Pigment (wt. %) | — | 2 | 4 | 6 | 8 |

The dry mix of particulate components identified in Table 1 were subsequently mixed with water to form a slurry having a Tap Flow (ASTM C1445-99) of between about 25% to about 30% to form a castable wet mix. The castable wet mix was poured into a 2 in³ mold and cured at about 700° F. The resulting test specimens were visually examined for color in comparison to a blackbody with specimens formed of formulations F3 through F5 deemed acceptable in terms of their black coloration.

### Example 2

The specimen obtained from formulation F4 in Example 1 above was further subjected to high temperature conditions of 2200° F. The specimen was visually inspected after high temperature exposure for 5 and 100 hours and was determined to have maintained its black color.

### Example 3

It was noticed in the preparation of the slurries in Example 1 that additional water was required to form a suitably flowable slurry for each of the formulations F2-F5 as compared to the base refractory material of formulation F1. The need for additional water was an indication that the target particle size distribution (Dₚₛₜ) of the formulation F1 was not commensurate with the particle size distributions of formulations F2-F5. The amounts of the components in the raw materials of the refractory base material were adjusted along with the addition of about 9 wt. % (based on total weight of the formulation) of brown fused alumina as a particle size distribution adjustment component. An essentially comparable but slightly greater amount of water was required for formulations F2-F5 as compared to formulation F1 (i.e., 6.0-6.5 wt. % viz. 5.5-6.0 wt. %). The essentially comparable amount of water required after particle size distribution adjustment was thus determinative that the particle size distribution of formulations F2-F5 were adjusted to be substantially comparable to the Dₚₛₜ of the refractory base material of formulation F1.

### Example 4

Formulation F4 was also evaluate the time the castable wet mix could be worked prior to being set. It was established that the formulation of F4 could be worked satisfactorily for between 1 to about 2.5 hours following the addition of water to the dry mixture. Formulation F4 was not capable of being worked after about 3 hours and was set in less than about 4.5 hours.

While reference is made to particular embodiments of the invention, various modifications within the skill of those in the art may be envisioned. Therefore, it is to be understood that the invention is not to be limited to the disclosed embodiment, but on the contrary, is intended to cover various modifications and equivalent arrangements included within the spirit and scope thereof.

What is claimed is:

1. A particulate high-emissivity (high-ε) refractory product comprising a mixture of:
(a) a particulate refractory base material which includes at least one particulate binder material, at least one particulate refractory raw material filler material and optionally at least one refractory additive; and
(b) a high-ε pigment in an amount sufficient to impart high-ε properties to the refractory product when cured of at least 0.80.

2. The particulate high-ε refractory product according to claim 1, wherein the refractory product has a final particle size distribution (D_{psf}) which is substantially equal to a predetermined target particle size distribution (Dₚₛₜ) of the particulate refractory base material.

3. The particulate high-ε refractory product according to claim 2, wherein the product further comprises an amount of a particle size distribution adjusting component sufficient to adjust the particle size distribution to achieve the D_{psf}.

4. The particulate high-ε refractory product according to claim 3, wherein the particle size distribution adjusting component is at least one inorganic metal oxide selected from the group consisting of brown fused alumina, white fused alumina and silicon carbide.

5. The particulate high-ε refractory product according to claim 3, wherein the particle size distribution adjusting component is present in an amount of up to about 20 wt. %, based on total weight of the particulate high-ε refractory material product

6. The particulate high-ε refractory product according to claim 2, wherein each of the Dₚₛₜ and the D_{psf} of the refractory product has a distribution of particles sizes of:
4 mesh<2%;
10 mesh=23% +/−5%;
20 mesh=42% +/−5%;
100 mesh=58% +/−5%;
200 mesh=64% +/−5%, and
−325 mesh=32% +/−5%.

7. The particulate high-ε refractory product according to claim 1, wherein the particulate binder material is present in the refractory base material in an amount of 2 wt. % to about 30 wt. %, based on total weight of the particulate high-ε refractory material product.

8. The particulate high-ε refractory product according to claim 1, wherein the refractory raw material filler material is present in the refractory base material in an amount of 50 wt. % to about 99 wt. %, based on total weight of the particulate high-ε refractory material product.

9. The particulate high-ε refractory product according to claim 1, wherein the refractory raw material filler includes at least one particulate refractory selected from the group consisting of alumina-silicates, aluminas, silicon carbides, zirconia-containing raw materials, magnesium-aluminum spinels, silica fume, calcined flint, fused silicas and silica sands.

10. The particulate high-ε refractory product according to claim 1, wherein the refractory raw material filler has an average particle size of below 3 mesh.

11. The particulate high-ε refractory product according to claim 1, wherein the at least one refractory additive is selected from the group consisting of dispersants, coagulants including set time accelerants and set time retardants, flocculants, deflocculants, plasticizers, colorants, foaming agents, water-retaining agents, anti-settling agents and preservatives.

12. The particulate high-ε refractory product according to claim 1, wherein the at least one refractory additive is present in an amount of up to about 15 wt. %, based on total weight of the particulate high-ε refractory material product

13. The particulate high-ε refractory product according to claim 1, wherein the high-ε pigment is present in an amount sufficient to impart an emissivity to the product when cured of between about 0.80 to about 0.95.

14. The particulate high-ε refractory product according to claim 13, wherein the high-ε pigment is present in an amount sufficient to impart an emissivity to the product when cured of between about 0.90 to about 0.93.

15. The particulate high-ε refractory product according to claim 13, wherein the high-ε pigment is present in an amount up to about 20 wt. %, based on the total weight of the particulate high-ε refractory product.

16. The particulate high-ε refractory product according to claim 13, wherein the high-ε pigment is present in an amount between about 2 wt. % to about 20 wt. %, based on the total weight of the particulate high-ε refractory product.

17. The particulate high-ε refractory product according to claim 16, wherein the high-ε pigment is present in an amount between about 3 wt. % to about 10 wt. %, based on the total weight of the particulate high-ε refractory product.

18. The particulate high-ε refractory product according to claim 16, wherein the high-ε pigment is present in an amount between about 4 wt. % to about 6 wt. %, based on the total weight of the particulate high-ε refractory product.

19. An castable refractory wet mix which comprises the particulate high-ε refractory product according to claim 1 and water.

20. A cured refractory component which is comprised of a cured residue of the castable refractory wet mix according to claim 19.

21. A method of forming the particulate high-ε refractory product according to claim 1, wherein the method comprises dry mixing the particulate refractory base material with an amount of a high-ε pigment sufficient to impart high-ε properties to the refractory product when cured of at least 0.80.

22. The method according to claim 21, which further comprises adding a particle size distribution adjusting component to the dry mixture of the refractory base material and the high-ε pigment sufficient to adjust a final particle size distribution (D_{psf}) of the high-ε refractory product to correspond substantially to a target particle size distribution (Dₚₛₜ) of the refractory base material.

23. A method of forming a castable refractory wet mix which comprises adding water to the particulate high-ε refractory product according to claim 1.

24. A method of forming an aqueous refractory slurry which comprises dispersing the particulate high-ε refractory product according to claim 1 in water.

25. A method for forming a refractory insulating foam material comprising:
(i) forming the aqueous refractory slurry according to claim 24; and
(ii) combining the aqueous refractory slurry with an aqueous foaming agent to prepare the refractory insulating foam material.
